(19) United States
(12) Patent Application Publication
(10) Pub. No.: US 2014/0268779 A1
(43) Pub. Date: Sep. 18, 2014

(54) LED LIGHT EMITTING DEVICE

(71) Applicants: Robert Sorensen, (US); Raghu Rao, (US); William King, (US); LITETRONICS INTERNATIONAL, INC., Alsip, IL (US)

(72) Inventors: Robert Sorensen, Alsip, IL (US); Raghu Rao, Woodridge, IL (US); William King, Champaign, IL (US)

(73) Assignee: Litetronics International, Inc., Alsip, IL (US)

(21) Appl. No.: 13/831,865

(22) Filed: Mar. 15, 2013

(51) Int. Cl. F21S 4/00; F21K 99/00

(52) U.S. Cl. CPC F21S 4/003; F21K 9/10
USPC 362/249.06; 362/382; 362/363

(57) ABSTRACT

An LED light source is disclosed herein. The LED light source has at least one LED die chip and at least two electrically conductive supports. The electrically conductive supports are configured and disposed to support and suspend each LED die chip. One or more LED die chips may be support and suspend with a series of electrically conductive supports to provide a string of LED die chips. A shell may be disposed about a string of LED die chips. One or more strings of LED die chips may be disposed in an enclosure.

### FIELD OF THE DISCLOSURE

This disclosure relates generally to light emitting diode (LED) devices, and more particularly, to a light emitting device having at least one LED die chip and associated electrical connectors.

### BACKGROUND

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

Traditional incandescent light bulbs have been and are currently used in a large variety of lighting products. An incandescent light bulb typically consists of one or more electrically resistive filaments that are mounted within a transparent envelope or shell, light bulb, or lamp. When a voltage is applied to the electrically resistive filament, the filament produces light by being heated to a high temperature until it glows. The hot filament is typically protected from air by a glass bulb, transparent envelope, or shell, that is filled with inert gas or evacuated. Other traditional light bulb technologies include halogen lamps and fluorescent lamps.

More recently, light emitting diode (LED) light bulbs are being developed and used. LEDs are electronic devices that typical comprises a semiconductor light source that emits light when subject to an electrical bias voltage. LEDs have been used as indicator lamps in many devices and are increasingly used for other lighting. With the application of an electrical current, LEDs are known to emit light across the visible, ultraviolet, and infrared wavelengths. LED light bulbs may have advantages over one or more traditional light bulbs. For example, LED light bulbs may have one or more advantages such as a longer service life, smaller size, higher light output, lower power consumption, and greater efficiency, than one or more traditional light bulbs.

LED typically refers to a packaged LED assembly which may comprise an LED die chip, an anvil holding the LED die chip within a reflective cavity, a post, a wire electrically connecting the LED die chip with the post, an anode leading from the post and a cathode leading from the anvil. Such component parts of an LED may be encased in transparent or semi-transparent material such as glass, polymer, or epoxy to anchor them in place and provide a lens for the LED.

There are a variety of ways that LEDs may be packaged, for example an LED package assembly may have one or a few LED die chips. Typically an LED has at least one LED die chip and other component parts enclosed in a transparent or semi-transparent material such as glass or polymer. The packaged LED assembly usually comes with wires leading to the two terminals of the LED device. In general, the lens and the wires of the LED package may be somewhat larger than the LED die chip. The packaging may serve to protect the LED die chip(s) and may allow the LED to be handled and integrated into different applications.

LEDs may be configured in different ways to provide different types of lighting solutions, including lamps, light bulbs, or lighting fixtures. For example, LEDs may be integrated into a lamp, light bulb, or lighting fixture that may be used to provide light in a residence or a business.

It may be desirable to have a light bulb that retains some of the aesthetics of the traditional light bulb, for example the aesthetic appearance of a filament emitting light or other aesthetic feature, and having one or more advantages associated with LEDs.

### SUMMARY

In one aspect of the present disclosure, an LED light source is provided. The LED light source has at least one LED die chip and at least two electrically conductive supports. Each LED die chip is supported and suspended with two electrically conductive supports.

In another aspect of the present disclosure, an LED light emitting device is provided. The LED light emitting device comprises at least one LED die chip, a first electrical contact, and a second electrical contact. Each electrical contact is configured and disposed to electrically connect with a power source. A first electrically conductive support is in electrical communication with the LED die chip and the first electrical contact. A second electrically conductive support in electrical communication with the LED die chip and the second electrical contact. The LED die chip is supported, suspended, and held with the first and second electrically conductive supports.

In a further aspect of the present disclosure, a string of LED die chips is provided. The string of LED die chips has a plurality of adjacently disposed LED die chips and an electrically conductive support extending, spacing, and providing electrical communication between each adjacently disposed LED die chip. Each electrically conductive support extending between each adjacently disposed LED die chip is configured to support, suspend, and hold each LED die chip in a desired orientation.

In a further aspect of the present disclosure, an LED lamp is provided. The LED lamp comprises a base configured to electrically connect with a socket. A driver is disposed with or proximate the base and is in electrical communication with the base. Two electrical leads are in electrical communication with the driver. At least two electrically conductive supports are provided, each electrically conductive support is in electrical communication with one electrical lead. At least one LED die chip is supported and suspended and in electrical communication with two electrically conductive supports. A shell is disposed about the electrically conductive supports and the LED die chip and is configured to pass light therethrough or transfer light therefrom.

### BRIEF DESCRIPTIONS OF THE DRAWINGS

The following figures, which are idealized, are not to scale and are intended to be merely illustrative of aspects of the present disclosure and non-limiting. In the drawings, like elements may be depicted by like reference numerals. The drawings are briefly described as follows.

FIG. 1 is a perspective view of an LED light source of the present disclosure;

FIG. 2 is a sectional view of a portion of the LED light source of FIG. 1 showing a string of LED die chips disposed in a shell configured to pass light therethrough or transfer light therefrom;

FIG. 3A is a frontal view of an LED die chip having two electrically conductive supports connected therewith, each being configured to support and suspend LED die chip;

FIG. 3B is a rearward view of the LED die chip of FIG. 3A showing the connection of the two electrically conductive supports with the LED die chip;

FIG. 4 shows a string of LED die chips of the present disclosure having the LED die chips disposed to emit a substantial portion of light in a parallel direction;

FIG. 5 shows a twisted string of LED die chips of the present disclosure;

FIG. 6 shows a string of LED die chips of the present disclosure having the LED die chips disposed to emit a substantial portion of light in alternating directions;

FIG. 7 shows a curving string of LED die chips of the present disclosure;

FIG. 8 shows a string of LED die chips disposed in a curving shell and electrically conductive supports having a cross configuration;

FIG. 9 is a schematic showing a string of LED die chips supported with angular electrically conductive supports;

FIG. 10 is a schematic showing a string of LED die chips with LED die chips in varying orientations;

FIG. 11 is a schematic showing a string of LED die chips having curved electrically conductive supports extending outside of a volume defined by lines extending between outer most surfaces of adjacently disposed LED die chips;

FIG. 12 is a schematic showing a string of LED die chips having linear electrically conductive supports extending within a volume defined by lines extending between outer most surfaces of adjacently disposed LED die chips;

FIG. 13 is a schematic showing a string of LED die chips having angular electrically conductive supports extending outside of a volume defined by lines extending between outer most surfaces of adjacently disposed LED die chips;

FIG. 14 is a schematic showing another embodiment of a string of LED die chips having curved electrically conductive supports extending outside of a volume defined by lines extending between outer most surfaces of adjacently disposed LED die chips;

FIG. 15 is a schematic showing another embodiment of a string of LED die chips having angular electrically conductive supports extending outside of a volume defined by lines extending between outer most surfaces of adjacently disposed LED die chips;

FIG. 16 is a schematic showing an embodiment of a string of LED die chips having curved electrically conductive supports extending beyond a side of adjacently disposed LED die chips;

FIG. 17 is a schematic showing an embodiment of a string of LED die chips having spiral electrically conductive supports extending beyond a side of adjacently disposed LED die chips;

FIG. 18 is a schematic showing an embodiment of a string of LED die chips having angular electrically conductive supports extending beyond a side of adjacently disposed LED die chips;

FIG. 19 is a schematic showing an embodiment of a string of LED die chips having curved electrically conductive supports extending beyond a side of adjacently disposed LED die chips and having LED die chips supported in different orientations;

FIG. 20 is a schematic showing an embodiment of a string of LED die chips having angular and linear electrically conductive supports supporting LED die chips in different orientations;

FIG. 21 is a schematic showing an embodiment of a string of LED die chips having electrically conductive supports supporting LED die chips in different orientations;

FIG. 22 is a schematic showing an embodiment of a string of LED die chips having curved electrically conductive supports supporting LED die chips in alternating outwardly facing orientations;

FIG. 23 is a schematic showing an embodiment of a string of LED die chips having linear electrically conductive supports supporting LED die chips in different outwardly facing orientations;

FIG. 24 is a schematic showing another embodiment of a string of LED die chips having curved electrically conductive supports supporting LED die chips in outwardly facing alternating orientations;

FIG. 25 is a perspective view of another embodiment of an LED light source of the present disclosure; and

FIG. 26 shows an electrically conductive support joined with an electrical lead.

### DETAILED DESCRIPTION

Reference will now be made in detail to the present exemplary embodiments and aspects of the present invention, examples of which are illustrated in the accompanying figures. The same reference numbers may be used in the figures to refer to the same or like parts. The presently disclosed embodiments, aspects, and features of the present invention are not to limit the presently claimed invention as other and different embodiments, aspects, and features will become apparent to one skilled in the art upon reading the present disclosure.

FIG. 1 shows LED light source 100 of the present disclosure. Light source 100 may have one or more aesthetic features of a traditional A-Shaped light bulb. However, it is to be understood that LED light source 100 may have other and/or different features such as one or more features associated with S6, S11, S14, B10, B11, BA15, C7, C9, C11, C15, A15, A17, AT19, A19, A21, A23, A25, PS25, PS30, PS35, PS40, PS52, ED17, ED23, ED28, BT19, BT28, BT37, BT56, R12, R14, R20, R25, R30, R40, R52, PAR16, PAR20, PAR30, PAR30 L, PAR36, PAR38, PAR46, PAR56 MR11, MR16, JD, JDR, G4 Capsule, G9 Capsule T2, T4, T5, T6, T6.5, T8, T10, T12, or other light bulbs.

LED light source 100 may have one or more shells 101, each configured to pass light therethrough or transfer light therefrom and disposed about one or more LED die chips (shown in FIG. 2). In the embodiment shown in FIG. 1, eight linear shells 101 are angularly disposed to form an octagonal configuration. A lower end of each shell 101 may be supported with lower supporting member 106 and an upper end of each shell 101 may be supported with supporting member 104. Upper and lower supporting members 104 and 106 may comprise electrically conductive materials. For example, both upper supporting member 104 and lower supporting member 106 may be electrically conductive throughout and may provide parallel current flow through each shell 101. Alternatively, only portions of both upper supporting member 104 and lower supporting member 106 may be electrically conductive and may provide current flow in series through each shell 101.

The ends of each shell 101 may be sealed or unsealed. In at least one embodiment, each shell 101 is sealed and each may be filled with one or more gases such as Helium, Nitrogen, and Argon, or one or more fluids. Each LED die chip supported in a gas or fluid filled shell 101 may have substantially its entire outer surface in contact with the gas or fluid. The gas or fluid may aid in heat dissipation or heat transfer from one or more LED die chips disposed in the sealed shell 101 and may help to increase the lifetime and/or reliability of the LED die chips disposed therein.

In at least one other embodiment, one or more shells 101 may have a polymer comprising material disposed therein. In this embodiment, the ends of each shell 101 may be sealed or unsealed. Each LED die chip disposed in shell 101 may have substantially its entire outer surface in contact with the polymer comprising material.

Electrical lead 110 is configured and disposed to provide electrical communication between base 108 and upper supporting member 104. Electrical lead 114 is configured and disposed to provide electrical communication between base 108 and lower supporting member 114. Electrical lead 114 could also be used to connect the electrical driver with the lower supporting member or the upper supporting member or both. Base 108 is shown as an Edison screw base. However, it is to be understood that the LED light source of the present disclosure may be void of a base, have a base configured to connect other existing sockets, or may be an integral component part of a lamp or luminaire. For example, base 108 may comprise an Edison screw base, as shown, a bi-pin base, a bayonet, or other configuration as is known in the art.

LED light source 100 may also comprise stem 116. Stem 116 may be comprised of a solid electrically insulating material such as glass or polymer. Stem 116 may extend from base 108 and may be disposed about at least a portion of electrical leads 110 and 114. Stem 116 may be configured and disposed to provide physical support to electrical leads 110 and 114 and may also help support shells 101. Shells 101 may be configured to pass light therethrough or transfer light therefrom.

LED light source 100 may also comprise an enclosure 112 configured to pass light therethrough or transfer light therefrom. Enclosure 112 may be sealed about shells 101. Enclosure 112 may be sealed to stem 116. In at least embodiment of the present disclosure, the ends of each shell 101 are unsealed and enclosure 112 is sealed with a gas such as Helium, Nitrogen, Argon, or combination thereof, contained therein. Each LED die chip supported in shells 101 may have substantially its entire outer surface in contact with the gas. The gas may provide for heat transfer in shells 101 and enclosure 112 and may aid in heat transfer from one or more LED die chips disposed in the unsealed shells 101. This embodiment may help to increase the lifetime and reliability of the LED die chips disposed shells 101. It is to be understood that one or both of the shells 101 and enclosure 112 may be sealed to provide one or more hermetically sealed envelopes. One or both envelopes may be filled with a gas or fluid and each may be filled with the same or different materials.

LED light emitting device 100 may be configured to change light output of at least one LED die chip to desired wavelengths of visible light. For example, one or more of LED die chips, shells 101, and/or enclosure 112 may have a phosphor containing material disposed therewith. For example, LED light emitting device 100 may have remote phosphor by disposing phosphor with shells 101, and/or enclosure 112.

LED light emitting device 100 may comprise one or more omnidirectional or substantially omnidirectional LED light tubes or shells 101. This may provide the aesthetic appearance of one or more filaments disposed in a shell (e.g. enclosure 112) as may be found with traditional incandescent light bulbs.

FIG. 2 shows a cut-away portion of LED light source 100 shown in FIG. 1. Each shell 101 may have one or more LED die chips 122 disposed therein, as shown in FIG. 2. For example, each shell 101 may have a plurality of LED die chips 122 disposed therein. Each of the plurality of LED die chips 122 disposed in a shell 101 may be interconnected with electrical conductive supports 124 to form a string of LED die chips 122. Electrical conductive supports 124 may be configured to support and suspend each LED die chip 122 and may provide LED light source 100 void of a substrate or LED carrier.

Electrical conductive supports 124 may be configured and disposed to support and suspend each LED die chip 122 in shell 101 and provide an LED light source void of a substrate. In at least one embodiment, electrical conductive supports 124 may be configured and disposed to hold each LED die chip 122 in shell 101 in a desired orientation and/or prevent or minimize contact between LED die chips 122 and shell 101.

Each LED die chip 122 may be supported, suspended, and held with electrical conductive supports 124, substantially equidistantly from adjacent LED die chips 122. Electrical conductive supports 124 may be configured and disposed to provide contact or a desired gap space between adjacent LED die chips 122. In at least one embodiment, electrical conductive supports 124 are configured to support and suspend LED die chips 122 and provide a desired heat transfer rate from the plurality of LED die chips 122 disposed in shell 101.

FIGS. 1 and 2 show at least one embodiment of an LED lamp 100 comprising a base 108 configured to electrically connect with a socket. A driver may be disposed with or proximate base 108, in a driver housing 117 for example, and in electrical communication with base 108. Two electrical leads, 110 and 114, are in electrical communication with the driver. At least two electrically conductive supports 124 are provided wherein each is in electrical communication with electrical leads 110 and 114. At least one LED die chip 122 is supported and suspended and in electrical communication with two electrically conductive supports 124. Shell 101 and/or enclosure 112 may be disposed about electrically conductive supports 124 and LED die chips 122. Shell 101 and/or enclosure 112 are configured to pass light therethrough or transfer light therefrom. FIG. 3A is a frontal view of LED die chip 122 being supported and suspended with two electrically conductive supports 124 and FIG. 3B is rearward view of the same. Each LED die chip 122 may be supported and suspended with two electrically conductive supports 124. The frontal view of FIG. 3A shows an embodiment of a configuration of an LED die chip 122. In this embodiment LED die chip 122 has a faceted side 123 that may that may be configured to emit a greater amount of light than other sides of LED die chip 122. However, it is to be understood that LED die chip 122 may have any configuration as in known in the art.

FIG. 3B shows LED die chip 122 having two electrical conductive supports 124 connected thereto, configured to support and suspend LED die chip 122. One electrical conductive support 124 may be connected to LED die chip's 122 anode and the other electrical conductive support 124 may be connected to LED die chip's 122 cathode for supplying an electrical current to each LED die chip 122. Electrical conductive supports 124 may have a configuration of ribbon connectors and may extend over a portion of reward side 121 of LED die chip 122. For example, electrical conductive supports 124 may have a rounded rectangular cross-sectional configuration and may cover a substantial portion of rearward side 121 of LED die chip 122. In at least one embodiment, electrically conductive supports 124 have a size, shape, and thermal conductivity to transfer a desired amount of heat from LED die chips 122. It is to be understood that electrical conductive supports 124 may have most any cross-sectional configuration as is known in the art and that electrical conductive supports 124 may connect with most any part of LED die chip 122.

FIG. 4 shows a string 140 of LED die chips 122 having electrically conductive supports 124 configured to disposed LED die chips 122 to emit a substantial portion of light in a parallel direction. At least two electrically conductive supports 124 may be configured and disposed to hold at least one LED die chip 122 in a desired orientation with respect to an LED light source, such as LED light source 100 shown in FIG. 1. For example, the frontal side 123 of each LED die chip 122 may be configured to emit a greater amount of light than other sides of LED die chip 122. The disposition of each LED die chip 122 having frontal side 123 pointed parallel with one another may cause LED die chips 122 of string 140 to emit a greater portion of light in a parallel direction. A reflective material may be disposed about rearward side 121 of LED die chips 122, thus increasing the parallel emission of light from LED die chips 122 in string 140.

In the configuration shown in FIG. 4, each LED die chip 122 in string 140 may be electrically connected in series with adjacent LED die chip(s) 122. However, it is to be understood that LED die chips 122 in a string 140 may be electrically connected in parallel. Each electrically conductive support 124 in string 140 may be under tension, compression, or may only provide support for the electrically conductive supports 124 and LED die chips 122, in string 140. String 140 may be disposed in an ambient atmosphere, within a light transmissible shell, and/or within a light transmissible enclosure.

FIG. 5 shows twisted string 150 of LED die chips 122 having electrically conductive supports 124 configured to dispose LED die chips 122 to emit a greater portion of light in at least two different directions. At least two electrically conductive supports 124 may be configured and disposed to hold at least one LED die chip 122 in a desired orientation with respect to other LED die chips 12 in string 150. For example, the frontal side 123 of each LED die chip 122 may be configured to emit a greater amount of light than other sides of LED die chip 122. The disposition of at least one LED die chip 122 having frontal side 123 pointed in a direction different than an adjacent LED die chip 122 in string 150, may enable string 150 to emit light in at least two different directions. In at least one embodiment, electrically conductive supports 124 are configured to support and suspend each LED die chip 122 to provide omnidirectional or substantially omnidirectional light output from string 150.

In the twisted configuration of string 150, each electrically conductive support 124 may be under latitudinal torque, tension, and/or may only provide support for electrically conductive supports 124 and LED die chips 122, in string 150. String 150 shows each LED die chip 122 having approximately a 90° rotation with respect to an adjacently disposed LED die chip 122. However, it is to be understood that each LED die chip in string 150 may be disposed with most any angular rotation with respect to an adjacently disposed LED die chip 122.

FIG. 6 shows string 160 of LED die chips 122 having LED die chips 122 disposed to emit light in alternating directions. A plurality of conductive supports 124 may be configured and disposed to hold each LED die chip 122 in a desired orientation with respect to other LED die chips 122 in string 160. For example, the frontal side 123 of each LED die chip 122 may be configured to emit a greater amount of light than other sides of LED die chip 122. The disposition of the LED die chips 122 having frontal side 123 pointed in alternating directions or in a direction opposite adjacent LED die chips 122 in string 160 may enable string 160 to emit light in a desired flux density about string 160. For example, string 160 may be configured to support and suspend each LED die chip 122 to provide omnidirectional or substantially omnidirectional light output therefrom.

In the disposition of LED die chips 122 in string 160, each electrically conductive support 124 in string 160 may be under tension, compression, or may only provide support for the electrically conductive supports 124 and LED die chips 122, in string 160. String 160 shows each LED die chip 122 having approximately a 180 rotation with respect to an adjacently disposed LED die chip 122. However, it is to be understood that each LED die chip 122 in string 160 may be supported and suspended with electrically conductive supports 124 to have most any angular rotation with respect to an adjacently disposed LED die chip 122.

FIG. 7 shows a curving string 170 of LED die chips 122 of the present disclosure. String 170 may electrically conductive supports 124 configured to dispose LED die chips 122 to emit a substantial amount of light in a radial direction. For example, a plurality of conductive supports 124 may be configured and disposed to hold each LED die chip 122 in string 170 having a circular configuration or a helical configuration. For instance, the frontal side 123 of each LED die chip 122 may be configured to emit a greater amount of light than other sides of LED die chip 122. The disposition of the LED die chips 122 having frontal side 123 pointed in a circular or helical configuration in string 170 may enable string 170 to emit light in a desired flux density.

Electrically conductive support 124 in string 170 may be under longitudinal torque or compression, or may have a configuration for supporting and suspending LED die chips without stress. String 170 shows each LED die chip 122 spaced about an outer perimeter of string 170. It is to be understood that each LED die chip in string 170 may be disposed with most any angular rotation with respect to an adjacently disposed LED die chip 122. In at least one embodiment, LED die chips 122 are disposed in a helical configuration which may impart an esthetic appearance of a compact fluorescent lamp to a lamp comprising string 170.

FIG. 8 shows a section 180 of an LED light source having a string of LED die chips 122 disposed in a curving shell 181, configured to pass light therethrough or transfer light therefrom, and electrically conductive supports 184 having a cross configuration. Electrically conductive supports 184 may have a size, shape, thermal conductivity and/or have other characteristic to transfer a desired amount of heat from LED die chips 122. For example, electrically conductive supports 184 may have a composition and/or configuration to provide a desired thermal conductivity and/or surface area for heat transfer to a gas or fluid of heat from LED die chips 122. For example, electrically conductive supports my comprise copper or copper alloy to provide a desired thermal conductivity.

Shell 181 may have a gas or fluid therein. In at least one embodiment, electrically conductive supports 184 have at least a portion extending outside of a volume defined by lines extending between outer most surfaces of adjacently disposed LED die chips 122. For example, electrically conductive supports 184 may have one or both latitudinal crossing portions extending outside of a volume defined by lines extending between outer most surfaces of adjacently disposed LED die chips 122 which may contact an inner surface of shell 181. The cross configuration of electrically conductive supports 184 may be configured to provide an LED light source having sections 180 with resistance to physical shock. Additionally or alternatively, the configuration may provide desired a desired heat transfer rate of heat generated with LED die chips 122. In at least one embodiment, electrically conductive supports 184 are in the form of an ‘X’ shaped wire with a rounded cross sectional configuration. In at least one other embodiment, electrically conductive supports 184 have a configuration or shape to provide a desired heat transfer rate from LED die chips 122. For example, a thickened electrically conductive support 184 may provide a desired heat transfer rate.

Electrically conductive supports 184 may be configured and disposed to hold LED die chips 122 in a desired orientation with respect to sections 180. Electrically conductive supports 184 may be in tension or compression or under latitudinal or longitudinal torque or may be under a negligible stress or force.

FIGS. 9 through 25 schematically show alternative embodiments or aspects of the present disclosure. It is to be understood that these embodiments or aspects are not to limit the scope of the presently claimed invention as other and different configurations of the presently claimed invention will become apparent to one skilled in the art upon reading the present disclosure. The electrically conductive supports depicted in FIGS. 9 through 25 may be in the form of a wire with a circular cross-section or may have other cross-sectional geometric configurations such as rectangular, oval, or other geometric configuration as known in the art. For example, the electrically conductive supports may be in the form of a ribbon with rounded or squared edges. The strings of LED die chips depicted in FIGS. 9 through 25 may be disposed in an ambient atmosphere, within a light transmissible shell, and/or within a light transmissible enclosure. The LED die chips depicted in FIGS. 9 through 25 may be disposed to emit a greater portion of light in a common or different directions.

FIG. 9 shows a string 190 having LED die chips 192 supported with angular electrically conductive supports 194. String 190 may be subject to tension, compression, latitudinal torque, and/or longitudinal torque. For example, conductive supports 194 may be elongated to dispose LED die chips 192 a desired distance apart, compressed to dispose LED die chips 192 in a desired proximity, twist about a longitudinal axis of string 190 disposing LED die chips about a circumference of string 190, or curved about a longitudinal axis of string 190. String 190 may be subject to a plurality of forces. For example, electrically conductive supports 194 may be configured to dispose LED die chips 192 about a helical configuration of a string 190. Electrically conductive supports 194 may be configured to dispose a portion of LED die chips 192 to contact an inner surface of a light transmissible shell.

FIG. 10 shows electrically conductive supports 204 supporting and suspending LED die chips 202 to form string 200. Electrically conductive supports 204 may be configured to support and suspend LED die chips 202 in varying orientations. Electrically conductive supports 204 may be linear or curved and may be subject to tension, compression, and/or torque. In at least one embodiment, electrically conductive supports 204 are configured to support and suspend each LED die chip 202 with face or side 203 outwardly with respect to a longitudinal axis of string 200. Face 203 may be void of electrical contacts and may have a higher light output than an inner side 201. In at least one other embodiment, electrically conductive supports 204 are configured to support and suspend a portion of LED die chips 202 with face 203 in different directions with respect to a longitudinal axis of string 200. For example, electrical conductive supports 204 may be configured to support and suspend LED die chips 202 in a twisted configuration having faces 203 directed outwardly and in a pattern of directions with respect to a longitudinal axis of string 200 such as outward, outward and upward, outward, and outward and downward. Electrically conductive supports 204 may be configured to dispose LED die chips 202 to contact an inner surface of a light transmissible shell.

FIG. 11 shows electrically conductive supports 214 supporting and suspending LED die chips 212 to form string 210. Electrically conductive supports 214 may be curved and may have portions extending outside of a volume defined by lines extending between outer most surfaces of adjacently disposed LED die chips 212. In at least one embodiment of string 210, electrically conductive supports 214 have a sideways ‘S’ configuration with a portion of each electrically conductive support 214 extending outwardly from two opposing sides of LED die chips 212. String 210 may be subject to tension, compression, or torque, which may elongate conductive supports 214 to dispose die chips 212 a desired distance apart, compress conductive supports 214 to dispose die chips 212 in a desired proximity, or bend or twist conductive supports 214 to face die chips 212 in different directions. Electrically conductive supports 422 may be configured to support and suspend LED die chips 212 to be gap spaced from an inner surface of a light transmissible shell.

FIG. 12 shows electrically conductive supports 224 supporting and suspending LED die chips 222 to form string 220. Electrically conductive supports 224 may be linear and may extending within a volume defined by lines extending between outer most surfaces of adjacently disposed LED die chips 222. String 220 may be subject to tension, compression, or torque, which may change the configuration of electrically conductive supports 224 to hold LED die chips 222 in a desired orientation or face adjacent LED die chips 222 to have a surface configured to emit a greater amount of light in different directions. Electrically conductive supports 224 may be configured to support and suspend LED die chips 222 and to contact an inner surface of a light transmissible shell.

FIG. 13 shows electrically conductive supports 234 supporting and suspending LED die chips 232 to form string 230. Electrically conductive supports 234 may be angular and may have portions extending outside of a volume defined by lines extending between outer most surfaces of adjacently disposed LED die chips 232. In at least one embodiment of string 230, electrically conductive supports 234 have a ‘U’ configuration with a portion of each electrically conductive support 234 extending outwardly from two opposing sides of LED die chips 232. String 230 may be subject to tension, compression, or torque, which may change the configuration of electrically conductive supports 234 to hold LED die chips 232 in a desired orientation. Electrically conductive supports 234 may be configured to support and suspend LED die chips 232 and to gap space them from an inner surface of a light transmissible shell.

FIG. 14 shows electrically conductive supports 244 supporting and suspending LED die chips 242 to form string 240. Electrically conductive supports 244 may have a curved configuration and may have portions extending outside of a volume defined by lines extending between outer most surfaces of adjacently disposed LED die chips 242. In at least one embodiment of string 240, electrically conductive supports 244 have a sideways ‘S’ configuration with its ends attached to adjacent LED die chips 242 and a central portion of each electrically conductive support 244 extending outwardly from two opposing sides of LED die chips 242. String 240 may be subject to tension, compression, or torque, which may elongate conductive supports 244 to dispose LED die chips 242 a desired distance apart, compress conductive supports 244 to dispose LED die chips 242 in a desired proximity, twist conductive supports 244 about a longitudinal axis of string 240 and face LED die chips 242 in different directions, or bend string 240 into a non-linear configuration. Electrically conductive supports 244 may be configured to support and suspend LED die chips 242 to be gap spaced from an inner surface of a light transmissible shell.

FIG. 15 shows electrically conductive supports 254 supporting and suspending LED die chips 252 to form string 250. Electrically conductive supports 254 may have an angular with portions extending outside of a volume defined by lines extending between outer most surfaces of adjacently disposed LED die chips 252. For example, electrically conductive supports 254 may have an ‘N’ configuration extending outwardly from two opposing sides of LED die chips 252. String 250 may be subject to tension, compression, or torque, which may elongate string 250, compress string 250, twist electrically conductive supports 254 and hold LED die chips 252 in different directions, or bend string 250 into a non-linear configuration. Electrically conductive supports 254 may be configured to support and suspend LED die chips 252 to be gap spaced from an inner surface of a light transmissible shell.

FIG. 16 shows electrically conductive supports 264 supporting and suspending LED die chips 262 to form string 260. Electrically conductive supports 264 may have a curved configuration and may have portions extending outside of a volume defined by lines extending between outer most surfaces of adjacently disposed LED die chips 262. In at least one embodiment of string 260, electrically conductive supports 264 have ‘U’ configuration with its central portion of each electrically conductive support 264 extending outwardly common sides of LED die chips 262. String 260 may be subject to tension, compression, or torque, which may elongate conductive supports 264 to dispose LED die chips 262 a desired distance apart, compress conductive supports 264 to dispose LED die chips 262 in a desired proximity, twist conductive supports 264 about a longitudinal axis of string 260 and face LED die chips 262 in different directions, or bend string 260 into a non-linear configuration. Electrically conductive supports 264 may be configured to support and suspend LED die chips 262 to be gap spaced from an inner surface of a light transmissible shell or support and suspend LED die chips 262 to be contact an inner surface of a light transmissible shell.

FIG. 17 shows electrically conductive supports 274 supporting and suspending LED die chips 272 to form string 270. Electrically conductive supports 274 may have a curved configuration and may have portions extending outside of a volume defined by lines extending between outer most surfaces of adjacently disposed LED die chips 272. In at least one embodiment of string 270, electrically conductive supports 274 have a spiral or looping configuration with its ends attached to adjacent LED die chips 272 and a central portion of each electrically conductive support 274 extending outwardly from common sides of LED die chips 272. String 270 may be subject to tension, compression, or torque, which may elongate conductive supports 274 to dispose LED die chips 272 a desired distance apart, compress conductive supports 274 to dispose LED die chips 272 in a desired proximity, twist conductive supports 274 about a longitudinal axis of string 270 and face LED die chips 272 in different directions, or bend string 270 into a non-linear configuration. Electrically conductive supports 274 may be configured to support and suspend LED die chips 272 to be gap spaced from an inner surface of a light transmissible shell or support and suspend LED die chips 272 to be contact an inner surface of a light transmissible shell.

FIG. 18 shows electrically conductive supports 284 supporting and suspending LED die chips 282 to form string 280. Electrically conductive supports 284 may have an angular configuration and may have portions extending outside of a volume defined by lines extending between outer most surfaces of adjacently disposed LED die chips 282. In at least one embodiment of string 280, electrically conductive supports 284 have an angular looping configuration with its ends attached to adjacent LED die chips 282 and a central portion of each electrically conductive support 284 extending outwardly from two common sides of LED die chips 282. String 280 may be subject to tension, compression, or torque, which may elongate conductive supports 284 to dispose LED die chips 282 a desired distance apart, compress conductive supports 284 to dispose LED die chips 282 in a desired proximity, twist conductive supports 284 about a longitudinal axis of string 280 and face LED die chips 282 in different directions, or bend string 280 into a non-linear configuration. Electrically conductive supports 284 may be configured to support and suspend LED die chips 282 to be gap spaced from an inner surface of a light transmissible shell or support and suspend LED die chips 282 to be contact an inner surface of a light transmissible shell.

FIG. 19 shows electrically conductive supports 294 supporting and suspending LED die chips 292 to form string 290. Electrically conductive supports 294 may have a curved configuration and may have portions extending outside of a volume defined by lines extending between outer most surfaces of adjacently disposed LED die chips 292. In at least one embodiment of string 290, electrically conductive supports 294 have a curved shape or linear shape with angled or curving ends attached to adjacent LED die chips 292. A central portion of at least a portion of electrically conductive supports 294 may extend outwardly from sides of LED die chips 292. String 290 may be subject to tension, compression, or torque, which may change a curvature of conductive supports 294, twist conductive supports 294 about a longitudinal axis of string 290 and face LED die chips 292 in different directions, or bend string 290 into a non-linear configuration. Electrically conductive supports 294 may be configured to support and suspend LED die chips 292 to be gap spaced from an inner surface of a light transmissible shell or support and suspend LED die chips 292 to be contact an inner surface of a light transmissible shell.

FIG. 20 shows electrically conductive supports 304 and 305 supporting and suspending LED die chips 302 to form string 300. Electrically conductive supports 304 may have a linear configuration and electrical conductive supports 305 may have an angular configuration which may have portions extending outside of a volume defined by lines extending between outer most surfaces of adjacently disposed LED die chips 302. String 300 may be subject to tension, compression, or torque, which may elongate string 300, twist conductive supports 305 and/or 305 about a longitudinal axis of string 300 and face LED die chips 302 in different directions, or bend string 300 into a non-linear configuration. Electrically conductive supports 305 may be configured to support and suspend LED die chips 302 to be gap spaced from an inner surface of a light transmissible shell.

FIG. 21 shows electrically conductive supports 314 supporting and suspending LED die chips 312 to form string 310. Electrically conductive supports 314 may have a linear configuration with one or both ends curved or angled and attached to adjacent LED die chips 312. String 310 may be subject to tension, compression, or torque. Electrical conductive supports 314 may be configured to support and suspend LED die chips 312 in different angular orientations as shown in FIG. 21. String 310 may be curved into a non-linear configuration. Electrically conductive supports 314 may be configured to support and suspend a portion of LED die chips 312 to contact inner surface of a light transmissible shell.

FIG. 22 shows electrically conductive supports 324 supporting and suspending LED die chips 322 to form string 320. Electrically conductive supports 324 may have a curved configuration and may be disposed inside a volume defined by lines extending between outer most surfaces of disposed LED die chips 322. In at least one embodiment of string 320, electrically conductive supports 324 have a curled configuration with its ends attached to adjacent LED die chips 322. String 320 may be subject to tension, compression, or torque, which may elongate conductive supports 324 to dispose LED die chips 322 a desired distance apart, compress conductive supports 324 to dispose LED die chips 322 in a desired proximity, twist conductive supports 324 about a longitudinal axis of string 320 and face LED die chips 322 in different directions, or bend string 320 into a non-linear configuration. Electrically conductive supports 324 may be configured to support and suspend LED die chips 322 to contact an inner surface of a light transmissible shell.

FIG. 23 shows electrically conductive supports 334 supporting and suspending LED die chips 332 to form string 330. Electrically conductive supports 334 may have a linear configuration. String 330 may be subject to tension or torque, which may twist conductive supports 334 about a longitudinal axis of string 330 and face LED die chips 332 in different directions, or bend string 330 into a non-linear configuration. Electrically conductive supports 334 may be configured to support and suspend LED die chips 332 to be gap spaced from or contact an inner surface of a light transmissible shell.

FIG. 24 shows electrically conductive supports 344 supporting and suspending LED die chips 342 to form string 340. Electrically conductive supports 340 may have a curved configuration and may have an ‘S’ configuration with its ends attached to adjacent LED die chips 342. String 340 may be subject to tension or torque, which may elongate conductive supports 344 to dispose LED die chips 342 a desired distance apart, twist conductive supports 344 about a longitudinal axis of string 340 and face LED die chips 342 in different directions, or bend string 340 into a non-linear configuration. Electrically conductive supports 344 may be configured to support and suspend LED die chips 242 to be gap spaced from or contact an inner surface of a light transmissible shell.

FIG. 25 shows LED light source 350. LED light source 350 may comprise one or more LED die chips 352, each being supported and suspended with two electrically conductive supports 354. The two electrically conductive supports 354 supporting and suspending each LED die chip 352 may be configured and disposed to hold the LED die chip 352 in a desired orientation with respect to LED light source 350. The two electrically conductive supports 354, supporting and suspending each LED die chip 352, may be in tension or compression or under latitudinal or longitudinal torque. The two electrically conductive supports 354, supporting and suspending each LED die chip 352, may have a size, shape, and/or thermal conductivity to transfer a desired amount of heat from at least one LED die chip.

LED light source 350 may comprise a plurality of LED die chips 352 disposed in a string wherein each LED die chip 352 may be electrically connected to an adjacent LED die chip 352 and each LED die chip 352 may be supported, suspended, and held in a desired orientation with two electrically conductive supports 354. Each LED die chip 352 in the string of LED die chips may have an light emitting surface disposed to emit light in a direction parallel with each other LED die chip 352 in the string of LED die chips 352. Alternatively, at least one LED die chip 352 in the string of LED die chips may have a light emitting surface disposed to emit light in a direction non-parallel with at least one other LED die chip 352 in the string of LED die chips 352.

LED light source 350 may have a shell 362 configured to pass light therethrough or transfer light therefrom and disposed about a string of LED die chips 352. Shell 362 may have a linear, curving, spiraling, or polygonal configuration. Shell 362 may have an electrical contact 360 disposed proximate each distal end thereof and each electrical contact 360 may be in electrical communication with an electrically conductive support 354 disposed at each end of a string of LED die chips 352. Shell 362 may have a polymer comprising material disposed therein and each LED die chip 352 may have substantially its entire outer surface in contact with the polymer comprising material. Shell 362 may be hermetically sealed or may have one or both distal ends open. In at least one embodiment, at least one LED die chip 352 is sealed within shell 362. Shell 362 may have a gas or fluid sealed therein and each LED die chip 352 supported in the gas or fluid may have substantially its entire outer surface in contact with the gas or fluid. LED light source 350 may be configured to be used as a light bulb wherein electrical contacts 360 may be configured and disposed for connection with existing sockets in a lamp. Alternatively, LED light source 350 may be a component part of a light bulb.

Turning back to FIGS. 1 and 2, LED light source 350 may be representative of one of the shells 101. In this embodiment, electrical contacts 360 may be configured to electrically connect with upper and lower supporting members 104 and 106. LED light source 350 may be enclosed in an enclosure configured to pass light therethrough or transfer light therefrom, such as enclosure 112. The enclosure may have a gas sealed therein. In at least one embodiment, shell 362 has an opening proximate each electrical contact 360 and each LED die chip 352, supported in shell 362, has substantially its entire outer surface in contact with a gas enclosed in an enclosure.

In at least one embodiment, LED light source 350 may comprise at least one LED die chip 352 and a first electrical and a second electrical contact 360, each configured and disposed to electrically connect with a power source. A first electrically conductive support 354 is disposed to be in electrical communication with an LED die chip 352 and the first electrical contact 360. The second electrically conductive support 354 is disposed to be in electrical communication with an LED die chip 352 and the second electrical contact 360. Each LED die chip is supported, suspended, and held with the first and said second electrically conductive supports 354. In at least one embodiment, LED light source 350 may configured to change output of at least one LED die chip 352 to desired wavelengths of visible light.

In at least one other embodiment, LED light source 350 may comprise a string of LED die chips 352. The string of LED die chips 352 may comprise a plurality of adjacently disposed LED die chips, each having an electrically conductive support 354 extending, spacing, and providing electrical communication therebetween. Each electrically conductive support 354, extending between each adjacently disposed LED die chip 352, is configured to support, suspend, and hold each LED die chip 352 in a desired orientation.

LED light source 350 may have LED shell 362 configured to pass light therethrough or transfer light therefrom and disposed about each LED die chip 352 and each electrically conductive support 354. Electrically conductive supports 354 may be configured to support one or more LED die chips 352 to contact an inner surface of shell 362 or electrically conductive supports 354 may be configured and disposed to hold each LED die chip 352 gap spaced from shell 362. In at least one embodiment, each electrically conductive support 354 is in tension and configured to hold LED die Chips gap spaced from shell 362. In at least one other embodiment, at least one electrically conductive support 354, extending between adjacently disposed LED die chips 352, has at least a portion extending outside of a volume defined by lines extending between outer most surfaces of the adjacently disposed LED die chips 352. One or more of the electrically conductive supports 354, disposed to provide electrical communication between adjacent said LED die chips 352, may be in contact with an inner surface of shell 362. For example, one or more electrically conductive supports 354 may have a cross, tee, curving, linear, angular, spiral, or other configuration.

LED light source 350 may have electrical connectors 354 configured to support and suspend a plurality of LED die chips 352 to have a substantial portion of light emitted in a parallel direction. Alternatively, LED light source 350 may have electrical connectors 354 configured to support and suspend at least one LED die chip 352 to have a light emitting surface disposed to a emit a greater amount of light in a direction non-parallel with at least one other LED die chip 352 in a string of LED die chips 352.

FIG. 26 shows electrically an conductive support joined with an electrical lead. For example, referring back to FIGS. 1 and 2, electrical conductive support 124 may be joined with upper supporting member 104, wherein upper supporting member 104 may be an electrical lead. LED die chips may be manufactured with a metal layer or eutectic bonding layer that may serve as the electrical connectors to the semiconducting material of an LED die chip, disposed in shell 101. There are a variety of ways that the electrical connectors and/or electrical conductive supports 124 be attached to the LED Die chip, including a eutectic bond, a solder bond, a welded bond, or an electrically conductive adhesive. Additionally, there are a number of ways that electrical connectors or electrical conductive supports 124, including metal wires and ribbons, may be joined. The joining methods include, but are not limited to, welding, soldering, affixing with an adhesive, or joining by mechanical attachment. Methods of mechanical attachment include wrapping one connector around the other or intertwining the connectors. These methods of mechanical attachment also achieve electrical communication between the connectors. Two or more electrical connectors can be tied into a knot to make both mechanical and electrical connection. In the example connection shown in FIG. 26, electrical conductive support 124 has a portion wound around upper supporting member 124 and is welded thereto, designated with 105.

In view of this disclosure, the technologies generally described for an LED light source comprising at least one LED die chip and at least two electrically conductive supports supporting and suspending the LED die chip(s) will enable one skilled in the art to practice many features or aspects of the present disclosure. Some of these features or aspects are presently disclosed. Some of the terms used herein may correlate with terms previously used. For example, light transmissible shell may be referred to as a tube and light transmissible enclosure may be referred to as a shell.

One feature or aspect of the present disclosure is believed at the time of the filing of this patent application to possibly reside broadly in a light source based on LEDs that is near to the center of an envelope of a light bulb and that is generally omnidirectional.

Another feature or aspect of the present disclosure is believed at the time of the filing of this patent application to possibly reside broadly in a light source supporting at least one LED die chip, wherein the LED die chip is a two-terminal electronic device that may have two electrical connections and may be void of component parts or packaging typically associated with LEDs.

Yet another feature or aspect of the present disclosure is believed at the time of the filing of this patent application to possibly reside broadly in a light source comprising one or more LEDs wherein the LEDs are electronic devices that emit light when subject to an electrical bias voltage. The LEDs may emit light at a given wavelength or set of wavelengths or color spectrum, which may be constant for a given LED. The LEDs may have an emission wavelength, or color of emitted light, that may be for example blue, green, red, amber, infrared, or ultraviolet. When a voltage is applied across the two terminals of the LED, light may be emitted from the LED. For example, an LED may require a sufficient voltage in order to emit light, for example, 1-10 V. The voltage may be constant or may be switched on and off. In the case of switching, or pulsed, operation, the LED may emit light only when the voltage exceeds a threshold voltage required for light emission.

Still another feature or aspect of the present disclosure is believed at the time of the filing of this patent application to possibly reside broadly in an LED light device having driver electronics that control the voltage applied to the LED and the current that flows through the LED. The driver electronics may also control switching or pulsing operation of the LED.

A further feature or aspect of the present disclosure is believed at the time of the filing of this patent application to possibly reside broadly in an LED light emitting device having multiple LEDs combined in an electrical circuit. For example, multiple LEDs may be combined in series, parallel, or in series and parallel with each other. The LEDs in the circuit may emit light when the voltage across the LED exceeds the threshold required for light emission.

Another feature or aspect of the present disclosure is believed at the time of the filing of this patent application to possibly reside broadly in a light source having LEDs configured in different ways to provide different types of lighting solutions, including lamps, light bulbs, or lighting fixtures. For example, LEDs may be integrated into a lamp, light bulb, or lighting fixture that may be used to provide light in a residence or a business. LEDs within the lighting may be selected from among different color light output. LEDs of different sizes and colors may be combined into a given lighting solution.

Still another feature or aspect of the present disclosure is believed at the time of the filing of this patent application to possibly reside broadly in an arrangement of multiple LEDs in different positions and orientations, wherein the LEDs may be packaged LEDs or LED die chips. In some aspects, standard LED packaging may prevent desirable positions and/or orientations of the LEDs. Examples of problems that may be caused with LED packages may include that the packaging may prevent close packing of the LEDs, and the wires or other components of the LED package may block the light emitted from the LED. Certain arrangements of packaged LED assemblies may not be practical, since the lens and wiring may prevent certain arrangements of the LEDs. It is thus may be desirable to integrate LED die chips, without the associated LED packaging, into lamps, light bulbs, and other lighting solutions that may avoid some of the problems associated with standard LED packaging.

A further feature or aspect of the present disclosure is believed at the time of the filing of this patent application to possibly reside broadly in LEDs made from electronic materials such as silicon or gallium arsenide compounds. These electronic materials may be processed in a semiconductor foundry that produces many LED electronic chips on a thin sheet or wafer. This semiconductor foundry process may form the semiconductor material as well as electrical contacts to allow electrical connection to the semiconductor material. The finished LEDs may be much thinner than they are wide. LEDs may be designed such that they emit light mostly parallel to their thinnest dimension, or they may be designed such that they emit light mostly orthogonal to their thinnest dimension. It may be desirable to arrange an LED or multiple LEDs in order to control the direction in which the light is emitted.

Another feature or aspect of the present disclosure is believed at the time of the filing of this patent application to possibly reside broadly in an LED light emitting device that is void of a substrate or carrier for the LEDs.

Yet another feature or aspect of the present disclosure is believed at the time of the filing of this patent application to possibly reside broadly in an LED light emitting device that is void of a substrate or carrier for LED die chips that are void of any packaging.

Still another feature or aspect of the present disclosure is believed at the time of the filing of this patent application to possibly reside broadly in an LED light emitting device that has LED die chips in differing orientations and or pointing in different directions.

A further feature or aspect of the present disclosure is believed at the time of the filing of this patent application to possibly reside broadly in an LED light emitting device that is omnidirectional or substantially omnidirectional.

Another feature or aspect of the present disclosure is believed at the time of the filing of this patent application to possibly reside broadly in an LED light emitting device having an arrangement of LEDs is that minimizes light being blocked by other LEDs, the wiring or LED mounting assembly, or by a portion of the light bulb assembly.

Yet another feature or aspect of the present disclosure is believed at the time of the filing of this patent application to possibly reside broadly in an LED light emitting device having an arrangement of LEDs to originate light from near the center of a light bulb.

One feature or aspect of the present disclosure is believed at the time of the filing of this patent application to possibly reside broadly in an LED light emitting device having at least one omnidirectional LED light tube that is a cylindrical light source that emits light in all directions around the circumference of the tube.

Another feature or aspect of the present disclosure is believed at the time of the filing of this patent application to possibly reside broadly in a light tube having LEDs configured in a row, where the row of LEDs is inside the tube and generally parallel to the main axis of the tube. Each LED may be electrically connected to the adjacent LEDs via metal wires. There may be electrical connections to the first LED in the row and the last LED in the row, such that the row of LEDs are connected in series. The tube may be glass or plastic or another material that allows transmission of light from the LEDs. The tube may be coated with a material such as phosphor, which may cause a shift in the wavelength of transmitted light.

Yet another feature or aspect of the present disclosure is believed at the time of the filing of this patent application to possibly reside broadly in an omnidirectional LED light tube having LEDs configured in a row, where the row of LEDs is inside the tube and generally parallel to the main axis of the tube. The ends of the tube may be sealed and the tube may be filled with a gas such as Helium, Nitrogen, or Argon. The presence of the gas may help to aid in heat dissipation or transfer from the LEDs, and may help to increase the lifetime and reliability of the LEDs. Each LED is electrically connected to the adjacent LEDs via a metal wire. The light tube may also be unsealed. In the case of the unsealed tube, the tube may be mounted in a hermetically sealed envelope that is filled with a gas such as Helium, Nitrogen, or Argon.

Still another feature or aspect of the present disclosure is believed at the time of the filing of this patent application to possibly reside broadly in an omnidirectional LED light tube having LEDs configured in a row, where the row of LEDs is inside the tube and generally parallel to the main axis of the tube. Each LED is electrically connected to the adjacent LEDs via a metal wire. The metal wire that connects each LED to the adjacent LED may be bent or twisted, such that each LED has a different orientation compared to the adjacent LED.

A further feature or aspect of the present disclosure is believed at the time of the filing of this patent application to possibly reside broadly in an omnidirectional LED light tube having LEDs configured in a row, where the row of LEDs is inside the tube and generally parallel to the main axis of the tube. Each LED is electrically connected to the adjacent LEDs via a metal wire. The metal wire that connects each LED to the adjacent LED has a shape such that each LED has a different orientation compared to the adjacent LED.

Another feature or aspect of the present disclosure is believed at the time of the filing of this patent application to possibly reside broadly in an LED light emitting device having several omnidirectional LED light tubes mounted within a shell of a light bulb lamp. The light emitted from each tube may be generally monochromatic. Alternatively, the light from each tube may be tailored to be a desired color by selecting the LEDs to have the appropriate number of green, blue, and red LEDs.

Yet another feature or aspect of the present disclosure is believed at the time of the filing of this patent application to possibly reside broadly in an omnidirectional LED light tube having LEDs configured in a row, where the row of LEDs is inside the tube and generally parallel to the main axis of the tube. Each LED is electrically connected to the adjacent LEDs via a metal wire. The omnidirectional LED light tube may be mounted in a transparent or semi-transparent envelope. Several omnidirectional LED light tubes may be mounted such that the color and the directionality of the light emitted from the envelope may be tailored based on the orientation and position of the omnidirectional LED light tubes as well as the orientation, position, and color of the LEDs within the omnidirectional LED light tubes.

Still another feature or aspect of the present disclosure is believed at the time of the filing of this patent application to possibly reside broadly in an omnidirectional LED light tube having LEDs configured in a row, where the row of LEDs is inside the tube and generally parallel to the main axis of the tube. Each LED is electrically connected to the adjacent LEDs via a metal wire. The metal wire that connects each LED to the adjacent LED is under tension or compression, and this tension or compression may cause the connecting wire to take on a shape such that each LED has a different orientation compared to the adjacent LED.

A further feature or aspect of the present disclosure is believed at the time of the filing of this patent application to possibly reside broadly in an omnidirectional LED light tube having LEDs configured in a string, where the string of LEDS is in the shape of an arc, and where the string of LEDs is within a tube that is generally in the shape of an arc. Each LED is electrically connected to the adjacent LEDs via a metal wire. Each LED has a different orientation compared to the adjacent LED.

Another feature or aspect of the present disclosure is believed at the time of the filing of this patent application to possibly reside broadly in an omnidirectional LED light tube having LEDs configured in a string, where the string of LEDS is in the shape of a spiral, and where the string of LEDs is within a tube that is generally in the shape of a spiral. Each LED is electrically connected to the adjacent LEDs via a metal wire. Each LED has a different orientation compared to the adjacent LED.

Yet another feature or aspect of the present disclosure is believed at the time of the filing of this patent application to possibly reside broadly in an omnidirectional LED light tube mounted within a shell that has the shape of a traditional light bulb lamp. Standard light bulb shapes may include S6, S11, S14, B10, B11, BA15, C7, C9, C11, C15, A15, A17, AT19, A19, A21, A23, A25, PS25, PS30, PS35, PS40, PS52, ED17 ED23 ED28 BT19 BT28 BT37 BT56, R12, R14, R20, R25, R30, R40, R52 PAR16, PAR20, PAR30. PAR30 L, PAR36, PAR38, PAR46, PAR56 MR11, MR16, JD, JDR, G4 Capsule, G9 Capsule T2, T4, T5, T6, T6.5, T8, T10, and T12, where the letter designates and glass shell shape and the number designates the maximum diameter of the lamp in 8ths of an inch. The shape, dimensions, and tolerances of these light bulb lamp shells are further defined by ANSI standards.

Another feature or aspect of the present disclosure is believed at the time of the filing of this patent application to possibly reside broadly in an omnidirectional LED light tube mounted within a shell that has the shape of a traditional light bulb lamp and is attached to an electrical socket base that is of a standard size, shape, and dimensions. Industry standard electrical socket bases may include E10, E11, E12, E14, E17, E26, E27, E39, E40, E26Skt, Screw terminals BA15, BA15d, GU10, GU24, G4 G9, G5.3, Min Bi Pin Med Bi PIN, Single PIN, RDC, G24q1, G24q2, G24q3, GX242, GX24 3, GX24 4, Gx32 2, GX32 3, 2GX7, 2G11, G23, GX23, G24d 2, and G24d 3. Alternatively, the omnidirectional LED light tube may be interfaced with a lighting fixture without the need for a socket.

Yet another feature or aspect of the present disclosure is believed at the time of the filing of this patent application to possibly reside broadly in an omnidirectional LED light tube that is mounted within a shell that has a stem.

One feature or aspect of the present disclosure is believed at the time of the filing of this patent application to possibly reside broadly in an omnidirectional LED light tube having LEDs configured in a row where each LED is electrically connected to the adjacent LEDs via a metal wire. The LED-wire assembly may be embedded in a polymer. The polymer may be formed into the shape of a tube, for example in a molding process. The plastic may incorporate a pigment or a phosphor to modify the emitted light.

Another feature or aspect of the present disclosure is believed at the time of the filing of this patent application to possibly reside broadly in an omnidirectional LED light tube having a coating. The coating may be inside the tube or outside the tube. The coating may be a metal coating, which may help to remove the heat from the omnidirectional LED light tube, or may help to reflect light from part of the tube. Alternatively, the coating may be an antireflective coating, which may allow for light to more efficiently pass through the tube. The antireflective coating may also allow for thermal radiation to more efficiently pass through the tube.

Yet another feature or aspect of the present disclosure is believed at the time of the filing of this patent application to possibly reside broadly in an omnidirectional LED light tube mounted within an envelope or a shell that has a coating. The coating may be metallic, which may help to remove heat from the LED light bulb. The coating may be a polymer or a fiberglass thread, which may serve to protect the glass if broken and to give the lamp a decorative filament glow. The lamp may be coated with a pigmented polymer to give different colors of the emitted light. Alternatively, the coating may be an antireflective coating, which allows for light to more efficiently pass through the shell. The antireflective coating may also allow for thermal radiation to more efficiently pass through the shell.

Still another feature or aspect of the present disclosure is believed at the time of the filing of this patent application to possibly reside broadly in an omnidirectional LED light tube having LEDs configured in a row, where the row of LEDs is inside the tube and generally parallel to the main axis of the tube. Each LED may be electrically connected to the adjacent LEDs via a metal wire. The metal wire that connects each LED to the adjacent LED may have a circular cross section. Alternatively, the metal wire that connects each LED the adjacent LED may be a ribbon, with cross section that has the shape of a square or rectangular. Alternatively, the metal wire that connects each LED to the adjacent LED may have a cross section that has the shape of a semicircle. The wire may also take on other shapes. The wire may be connected to the LED using wire bonding, welding, soldering, gluing, or other processes that are known to make electrical connections between wires and semiconductor devices.

A further feature or aspect of the present disclosure is believed at the time of the filing of this patent application to possibly reside broadly in LEDs within an omnidirectional light tube having a transparent electrical contact, such that light is emitted from the entire LED. Alternatively, the LEDs may have an electrical contact that is reflective or partially reflective. The reflective or partially reflective electrical contact may be engineered to have size and shape such that it reflects or blocks only a minimally small portion of the light emitted from the LED.

Another feature or aspect of the present disclosure is believed at the time of the filing of this patent application to possibly reside broadly in an omnidirectional LED light tube having LEDs configured in a row, where the row of LEDs is inside the tube and generally parallel to the main axis of the tube. Each LED is electrically connected to the adjacent LEDs via a metal wire. The metal wire that connects each LED to the adjacent LED has a circular cross section. Alternatively, the metal wire that connects each LED the adjacent LED is a ribbon, with cross section that has the shape of a square or rectangular. Alternatively, the metal wire that connects each LED to the adjacent LED has a cross section that has the shape of a semicircle. The wire may also take on other shapes. The wire may be connected to the LED using wire bonding, welding, soldering, gluing, or other processes that are known to make electrical connections between wires and semiconductor devices.

Yet another feature or aspect of the present disclosure is believed at the time of the filing of this patent application to possibly reside broadly in an omnidirectional LED light tube having LEDs configured in a row, where each LED is electrically and mechanically connected to the adjacent LEDs via a metal wire. The metal wire may have mechanical properties and size such that it provides mechanical as well as electrical connections between the LEDs. The shape of the wire and the strength of the mechanical connections between the LEDs may provide the overall shape of the row of the LED-wire assembly. The metal wires may be bent, twisted, cut, or formed into a non-linear shape either before or after attachment to the LEDs.

Still another feature or aspect of the present disclosure is believed at the time of the filing of this patent application to possibly reside broadly in an omnidirectional LED light tube having LEDs configured in a row, where each LED is electrically and mechanically connected to the adjacent LEDs via a metal wire. The LED-wire assembly is maintained in tension or compression, such that the mechanical force on the LED-wire assembly may provide for the specific orientations of the LEDs. The combination of the wire shape, type, and connection to the LED, along with the force applied to the LED-wire assembly, may cause the LEDs to point in different directions.

A further feature or aspect of the present disclosure is believed at the time of the filing of this patent application to possibly reside broadly in a light tube having LEDs configured in a row, where the row of LEDs is inside the tube. Each LED is electrically connected to the adjacent LEDs via a metal wire. The tube is a nonlinear shape, such as an arc or a spiral. The LED-wire assembly has sufficient flexibility to be inserted into a tube of a non-linear shape, or to be bent into a non-linear shape and then mated with a tube. The wires connecting the LEDs may be bent or formed either before or after attachment to the LEDs.

Another feature or aspect of the present disclosure is believed at the time of the filing of this patent application to possibly reside broadly in an omnidirectional LED light tube having LEDs configured in a row, where each LED is electrically and thermally connected to the adjacent LEDs via a metal wire. The metal wire has thermal properties and size such that it may remove heat from the LEDs.

Yet another feature or aspect of the present disclosure is believed at the time of the filing of this patent application to possibly reside broadly in a light tube having LEDs configured in a row, where the row of LEDs is inside the tube and generally parallel to the main axis of the tube. Each LED is electrically connected to the adjacent LEDs via a metal wire. The LEDs may be additionally attached to a flexible material such as a polymer, which may provide additional mechanical attachment and help to provide for the orientation of the LEDs.

One feature or aspect of the present disclosure is believed at the time of the filing of this patent application to possibly reside broadly in an omnidirectional LED light tube integrated into a lamp having an envelope shell, a stem, and a base, and a thermal element that helps to remove heat from the lamp. The thermal element may be for example a heat spreader, an air-cooled heat sink, or a heat pipe.

Another feature or aspect of the present disclosure is believed at the time of the filing of this patent application to possibly reside broadly in LEDs within an omnidirectional LED light tube that emit primarily green light, primarily blue light, or primarily red light. Alternatively, the LEDs within the tube may be selected such that there are different numbers of green-emitting LEDs, blue-emitting LEDS, or red-emitting LEDs. LEDs of these different colors may be arranged to tailor the color of the light emitted from the omnidirectional LED light tube.

Yet another feature or aspect of the present disclosure is believed at the time of the filing of this patent application to possibly reside broadly in an omnidirectional LED light tube electrically connected to an electronic driving circuit. The electronic driving circuit may convert an AC voltage from a standard residential or commercial power supply into a DC voltage that drives the LEDs. Alternatively, the electronic driving circuit may convert an AC voltage from a standard residential or commercial power supply into a switched or pulsed voltage source. The electronic driving circuit may drive the LEDs in a way that generates more light or less light. One or more electronic driving circuits may be used to drive one or more omnidirectional LED light tubes, in order to modulate the color and intensity of the light emitted from the lamp. The electronic driving circuit may provide an electronic interface with a traditional lighting dimmer or with other light bulb dimming solutions.

Still another feature or aspect of the present disclosure is believed at the time of the filing of this patent application to possibly reside broadly in multiple omnidirectional LED light tubes mounted within a shell, and electrically connected to an electronic driving circuit. The electronic driving circuit may independently control the intensity of each of the omnidirectional LED light tubes. The omnidirectional LED light tubes may each emit light of a different color. The electronic driving circuit may thus modulate the light output from the lamp to have different intensity and color, where the intensity and color are independently controlled.

A further feature or aspect of the present disclosure is believed at the time of the filing of this patent application to possibly reside broadly in multiple omnidirectional LED light tubes mounted within a shell, and electrically connected to an electronic driving circuit. The electronic driving circuit may independently control the intensity of each of the omnidirectional LED light tubes. The tubes could be switched on and off one at a time or in groups, or the intensity may be modulated for one light at a time or in groups. The lamp may be used as a traditional three-way light bulb with light intensity set as either high, medium, or low.

Another feature or aspect of the present disclosure is believed at the time of the filing of this patent application to possibly reside broadly in an omnidirectional LED light tube mounted within a shell. The shell may also contain exposed metal parts that are used for electrical connection or heat removal. The exposed metal parts may be coated with a plastic sheath or polymer, such as silicone or other electrically nonconductive material to prevent electrical shock if the envelope is broken while connected to an electrical source.

Yet another feature or aspect of the present disclosure is believed at the time of the filing of this patent application to possibly reside broadly in a string of LEDs connected by wires, where each LED is connected to the adjacent LED by one wire, where the shape of the LEDs and the wires provides the shape of the LED-wire assembly, and where the LEDs are not otherwise mounted on a substrate.

Still another feature or aspect of the present disclosure is believed at the time of the filing of this patent application to possibly reside broadly in a string of wire-mounted LEDS is in tension.

A further feature or aspect of the present disclosure is believed at the time of the filing of this patent application to possibly reside broadly in a string of wire-mounted LEDs is in compression.

Another feature or aspect of the present disclosure is believed at the time of the filing of this patent application to possibly reside broadly in a string of wire-mounted LEDs where the LEDs are all pointed in the same direction.

Yet another feature or aspect of the present disclosure is believed at the time of the filing of this patent application to possibly reside broadly in a string of wire-mounted LEDs where the LEDs are not all pointed in the same direction.

One feature or aspect of the present disclosure is believed at the time of the filing of this patent application to possibly reside broadly in a string of wire-mounted LEDs where each LED is pointed in a direction that is different than the adjacent LED.

Another feature or aspect of the present disclosure is believed at the time of the filing of this patent application to possibly reside broadly in a string of LEDs connected by wires, where each LED is connected to the adjacent LED by one wire, and the LEDs are also connected to a flexible substrate.

Yet another feature or aspect of the present disclosure is believed at the time of the filing of this patent application to possibly reside broadly in an omnidirectional LED light tube, in which the wires have sufficient thickness to remove heat from the LEDs.

Still another feature or aspect of the present disclosure is believed at the time of the filing of this patent application to possibly reside broadly in an omnidirectional LED light tube, having a string of LEDs inside a tube, where each LED is connected to the adjacent LED by one wire, and where each LED is pointed in a direction that is different than the adjacent LED.

A further feature or aspect of the present disclosure is believed at the time of the filing of this patent application to possibly reside broadly in an omnidirectional LED light tube in which the center of the tube follows the shape of a line.

Another feature or aspect of the present disclosure is believed at the time of the filing of this patent application to possibly reside broadly in an omnidirectional LED light tube in which the tube has the shape of an arc.

Yet another feature or aspect of the present disclosure is believed at the time of the filing of this patent application to possibly reside broadly in an omnidirectional LED light tube in which tube has the shape of a spiral.

Still another feature or aspect of the present disclosure is believed at the time of the filing of this patent application to possibly reside broadly in a lamp containing a plurality of omnidirectional light tubes, with the omnidirectional light tubes assembled into a shape of a polygon, a spiral, or an arc.

A further feature or aspect of the present disclosure is believed at the time of the filing of this patent application to possibly reside broadly in an omnidirectional LED light tube, where electrical connections extend from the ends of the tube.

Another feature or aspect of the present disclosure is believed at the time of the filing of this patent application to possibly reside broadly in an omnidirectional LED light tube, consisting of a string of LEDs inside a tube, where each LED is connected to the adjacent LED by one wire, and where each LED is pointed in a direction that is different than the adjacent LED, and where the tube is hollow and filled with gas and sealed.

Yet another feature or aspect of the present disclosure is believed at the time of the filing of this patent application to possibly reside broadly in an omnidirectional LED light tube, consisting of a string of LEDs inside a tube, where each LED is connected to the adjacent LED by one wire, and where each LED is pointed in a direction that is different than the adjacent LED, and where the tube consists of a material that changes the color of the emitted light.

One feature or aspect of the present disclosure is believed at the time of the filing of this patent application to possibly reside broadly in an omnidirectional LED light tube, consisting of a string of LEDs inside a tube, where each LED is connected to the adjacent LED by one wire, and where each LED is pointed in a direction that is different than the adjacent LED, and where the LEDs do not contain a reflective layer such that they emit light in all directions.

Another feature or aspect of the present disclosure is believed at the time of the filing of this patent application to possibly reside broadly in a lamp that consists of a shell, a base, and one or more omnidirectional LED light tubes.

Yet another feature or aspect of the present disclosure is believed at the time of the filing of this patent application to possibly reside broadly in a lamp that consists of a shell, a stem, a base, and one or more omnidirectional LED light tubes.

Still another feature or aspect of the present disclosure is believed at the time of the filing of this patent application to possibly reside broadly in a lamp that consists of a shell, a stem, a base, an electrical driver, and one or more omnidirectional LED light tubes.

A further feature or aspect of the present disclosure is believed at the time of the filing of this patent application to possibly reside broadly in a lamp that consists of a shell, a stem, a base, an electrical driver that interfaces with an AC power source, and one or more omnidirectional LED light tubes.

Another feature or aspect of the present disclosure is believed at the time of the filing of this patent application to possibly reside broadly in a lamp that consists of a shell, a stem, a base, an electrical driver that interfaces with a DC power source, and one or more omnidirectional LED light tubes.

Yet another feature or aspect of the present disclosure is believed at the time of the filing of this patent application to possibly reside broadly in a lamp that consists of a shell, a stem, a base, an electrical driver, a heat removing element such as a heat spreader, heat sink, or heat pipe, and one or more omnidirectional LED light tubes.

Still another feature or aspect of the present disclosure is believed at the time of the filing of this patent application to possibly reside broadly in a lamp where a portion of the shell, stem, or base is coated with a heat conductive material, where the presence of the heat conductive material modifies the heat flow and temperature distribution within the lamp.

A further feature or aspect of the present disclosure is believed at the time of the filing of this patent application to possibly reside broadly in a lamp that consists of a shell, a base, and one or more omnidirectional LED light tubes, in which the shell envelope has one of the following traditional light bulb shapes: S6, S11, S14, B10, B11, BA15, C7, C9, C11, C15, A15, A17, AT19, A19, A21, A23, A25, PS25, PS30, PS35, PS40, PS52, ED17, ED23, ED28, BT19, BT28, BT37, BT56, R12, R14, R20, R25, R30, R40, R52 PAR16, PAR20, PAR30, PAR30 L, PAR36, PAR38, PAR46, PAR56 MR11, MR16, JD, JDR, G4 Capsule, G9 Capsule T2, T4, T5, T6, T6.5, T8, T10, T12.

Another feature or aspect of the present disclosure is believed at the time of the filing of this patent application to possibly reside broadly in a lamp that consists of a shell, a base, and one or more omnidirectional LED light tubes that is electrically connected to the fixture socket using one of the following industry standard bases E10, E11, E12, E14, E17, E26, E27, E39, E40, E26Skt, Screw terminals BA15, BA15d, GU10, GU24, G4, G9, G5.3, Min Bi Pin Med Bi PIN, Single PIN, RDC, G24q1, G24q2, G24q3, GX242, GX24 3, GX24 4 Gx32 2, GX32 3, 2GX7, 2G11, G23, GX23, G24d 2, G24d 3.

Yet another feature or aspect of the present disclosure is believed at the time of the filing of this patent application to possibly reside broadly in an omnidirectional LED light tube that is at least partially coated with a reflective material, or antireflective material, or diffusion material, or protective resin material, or color changing material, or a phosphor material for changing the color spectrum.

One feature or aspect of the present disclosure is believed at the time of the filing of this patent application to possibly reside broadly in an omnidirectional LED light tube, consisting of a string of LEDs inside a tube, where each LED is connected to the adjacent LED by one wire, and where each LED is pointed in a direction that is different than the adjacent LED, and where the material of the tube contains a dopant to change the spectral output or color of the emitted light.

Another feature or aspect of the present disclosure is believed at the time of the filing of this patent application to possibly reside broadly in a lamp that contains at least one omnidirectional LED light tube where part of the envelope shell surface is coated with a reflective material, or antireflective material, or diffusion material, or protective resin material, or color changing material, or pigment material, or a phosphor material, such that the coating changes the color spectrum or redirects the light.

Yet another feature or aspect of the present disclosure is believed at the time of the filing of this patent application to possibly reside broadly in a lamp that contains at least one omnidirectional LED light tube where the surface of the light tube is transparent and uncoated, and where part of the envelope shell surface is coated with a reflective material, or antireflective material, or diffusion material, or protective resin material, or color changing material, or pigment material, or a phosphor material, such that the coating changes the color spectrum or redirects the light.

Still another feature or aspect of the present disclosure is believed at the time of the filing of this patent application to possibly reside broadly in a lamp that contains at least one omnidirectional LED light tube where at least part of the envelope shell contains a dopant to modify the wavelength of light that is transmitted through the shell.

A further feature or aspect of the present disclosure is believed at the time of the filing of this patent application to possibly reside broadly in a string of LEDs connected by wires, where each LED is connected to the adjacent LED by one wire, where the electrical contacts on the LEDs are transparent, where the shape of the LEDs and the wires provides the shape of the LED-wire assembly, and where the LEDs are not otherwise mounted on a substrate.

Another feature or aspect of the present disclosure is believed at the time of the filing of this patent application to possibly reside broadly in a string of LEDs connected by wires, where each LED is connected to the adjacent LED by one wire, where the electrical contacts on the LEDs have been tailored to minimize reflection of the emitted light, where the shape of the LEDs and the wires provides the shape of the LED-wire assembly, and where the LEDs are not otherwise mounted on a substrate.

Yet another feature or aspect of the present disclosure is believed at the time of the filing of this patent application to possibly reside broadly in a lamp that contains at least one omnidirectional LED light tube that contains a combination of LED chips that emit blue, red, green, blue, red, green, amber, infrared, or ultraviolet light, where the tube has phosphor coating that modifies the light that is emitted from the tube.

Still another feature or aspect of the present disclosure is believed at the time of the filing of this patent application to possibly reside broadly in a lamp that contains at least one omnidirectional LED light tube, where the LEDs emit light that is a combination of yellow and red such that the emitted light is similar to light emitted by an incandescent light when dimmed.

A further feature or aspect of the present disclosure is believed at the time of the filing of this patent application to possibly reside broadly in a lamp that contains at least one omnidirectional LED light tube, where the envelope shell is frosted or white such that it diffuses the light emitted from the lamp.

Another feature or aspect of the present disclosure is believed at the time of the filing of this patent application to possibly reside broadly in a lamp that contains at least one omnidirectional LED light tube, where the envelope shell is clear transparent glass cover such that the inside filament light tubes to be seen clearly through the glass.

Yet another feature or aspect of the present disclosure is believed at the time of the filing of this patent application to possibly reside broadly in a lamp that contains at least one omnidirectional LED light tube, where the envelope shell contains a gas and is hermetically sealed.

One feature or aspect of the present disclosure is believed at the time of the filing of this patent application to possibly reside broadly in a lamp that contains at least one omnidirectional LED light tube, where the envelope shell contains a gas and is hermetically sealed.

Another feature or aspect of the present disclosure is believed at the time of the filing of this patent application to possibly reside broadly in a lamp that contains at least one omnidirectional LED light tube and a heat spreader or heat pipe.

Yet another feature or aspect of the present disclosure is believed at the time of the filing of this patent application to possibly reside broadly in a lamp that consists of a shell, a stem, a base, and one or more omnidirectional LED light tubes, and where the lamp contains a thermal element.

Still another feature or aspect of the present disclosure is believed at the time of the filing of this patent application to possibly reside broadly in a lamp that contains a plurality of omnidirectional LED light tubes, where each tube is interfaced with an electrical driving circuit that may independently control the intensity of light emitted from each of the omnidirectional LED light tubes.

A further feature or aspect of the present disclosure is believed at the time of the filing of this patent application to possibly reside broadly in a lamp that contains a plurality of omnidirectional LED light tubes, where each tube emits light at a different color, where each tube is interfaced with an electrical driving circuit that may independently control the intensity of light emitted from each of the omnidirectional LED light tubes.

Another feature or aspect of the present disclosure is believed at the time of the filing of this patent application to possibly reside broadly in a lamp that contains a plurality of omnidirectional LED light tubes, where some of the LED light tubes are coated in phosphor, where each tube emits light at a different color, where each tube is interfaced with an electrical driving circuit that may independently control the intensity of light emitted from each of the omnidirectional LED light tubes.

1. An LED light source comprising:
at least one LED die chip;
at least two electrically conductive supports; and
said LED die chip being supported and suspended with two said electrically conductive supports.

2. The LED light source of claim 1 wherein said at least two electrically conductive supports are configured and disposed to hold said at least one LED die chip in a desired orientation with respect to said LED light source.

3. The LED light source of claim 2 wherein said at least two electrically conductive supports are in tension or compression or under latitudinal or longitudinal torque.

4. The LED light source of claim 2 wherein said at least two electrically conductive supports have a size, shape, and thermal conductivity to conduct a desired amount of heat from said at least one LED die chip.

5. The LED light source of claim 1 comprising a plurality of LED die chips disposed in a string, each said LED die chip being electrically connected to an adjacent LED die chip and each said LED die chip being supported, suspended, and held in a desired orientation with two said electrically conductive supports.

6. The LED light source of claim 5 wherein each said LED die chip in the string of LED die chips has a light emitting surface disposed to emit light in a direction parallel with each other said LED die chip in the string of LED die chips.

7. The LED light source of claim 5 wherein at least one said LED die chip in the string of LED die chips has a light emitting surface disposed to emit light in a direction non-parallel with at least one other said LED die chip in the string of LED die chips.

8. The LED light source of claim 5 further comprising a shell configured to pass light therethrough or transfer light therefrom, said shell being disposed about the string of LED die chips.

9. The LED light source of claim 8 wherein said shell has a linear, curving, spiraling, or polygonal configuration.

10. The LED light source of claim 8 wherein said shell has an electrical contact disposed proximate each distal end thereof, each said electrical contact being in electrical communication with one said electrically conductive support disposed at each end of the string of LED die chips.

11. The LED light source of claim 10 wherein said shell has a polymer comprising material therein and each said LED die chip has substantially its entire outer surface in contact with the material.

12. The LED light source of claim 1 wherein said at least one LED die chip is sealed within an enclosure configured to pass light therethrough or transfer light therefrom.

13. The LED light source of claim 12 wherein said enclosure has a gas sealed therein and each said LED die chip supported in the gas has substantially its entire outer surface in contact with the gas.

14. An LED light emitting device comprising:
at least one LED die chip;
a first electrical contact and a second electrical contact, each electrical contact being configured and disposed to electrically connect with a power source;
a first electrically conductive support in electrical communication with said at least one LED die chip and said first electrical contact;
a second electrically conductive support in electrical communication with said at least one LED die chip and said second electrical contact;
each said LED die chip being supported, suspended, and held with said first and said second electrically conductive supports.

15. The LED light emitting device of claim 14 configured to change light output of at least one said LED die chip to desired wavelengths of visible light.

16. A string of LED die chips comprising:
a plurality of adjacently disposed LED die chips;
an electrically conductive support extending, spacing, and providing electrical communication between each said adjacently disposed LED die chip;
each said electrically conductive support extending between each said adjacently disposed LED die chip being configured to support, suspend, and hold each said LED die chip in a desired orientation.

17. The string of LED die chips of claim 16 further comprising a shell configured to pass light therethrough or transfer light therefrom, said shell being disposed about each said LED die chip wherein each said electrically conductive support extending between each said adjacently disposed LED die chip is configured and disposed to hold each said LED die chip gap spaced from said shell.

18. The string of LED die chips of claim 17 wherein each said electrically conductive support extending between each said adjacently disposed LED die chip has at least a portion extending outside of a volume defined by lines extending between outer most surfaces of the adjacently disposed LED die chips.

19. The string of LED die chips of claim 18 wherein each said electrically conductive support disposed to provide electrical communication between adjacent said LED die chips contacts an inner surface of said shell.

20. The string of LED die chips of claim 19 wherein each said electrically conductive support disposed to provide electrical communication between adjacent said LED die chips has a configuration selected from the group consisting of cross, tee, curving, linear, angular, spiral, and combinations thereof.

21. The string of LED die chips of claim 16 wherein at least one said LED die chip has a light emitting surface disposed to a emit a greater amount of light in a direction non-parallel with at least one other said LED die chip in the string of LED die chips.

22. An LED lamp comprising:
a base configured to electrically connect with a socket;
a driver disposed with or proximate said base and in electrical communication with said base;
two electrical leads in electrical communication with said driver;
at least two electrically conductive supports, each said electrically conductive support being in electrical communication with one said electrical lead;
at least one LED die chip;
said LED die chip being supported and suspended and in electrical communication with two said electrically conductive supports; and
a shell disposed about said electrically conductive supports and said at least one LED die chip, said shell being configured to pass light therethrough or transfer light therefrom.

23. The LED lamp of claim 22 wherein said electrically conductive supports are joined to said LED die chip with a eutectic bond, a solder bond, a welded bond, or an electrically conductive adhesive.

24. The LED lamp of claim 22 wherein at least one said electrically conductive support is joined to one said electrical lead with a eutectic bond, a solder bond, a welded bond, or an electrically conductive adhesive.

25. The LED lamp of claim 22 wherein at least one said electrically conductive support is joined to one said electrical lead with a mechanical bond including a knot or a wrap.
